(19) United States
(12) Patent Application Publication
(10) Pub. No.: US 2008/0083102 A1
(43) Pub. Date: Apr. 10, 2008

(54) Structure and method for connecting cremation ashes with living plants

(76) Inventor: Raymond Keith Johnson, Barre, VT (US)

Correspondence Address: Thomas G. Ference, 38 Thasha Lane #C6, Essex Junction, VT, 05452-4508, US

(21) Appl. No.: 11/542,709

(22) Filed: Oct. 4, 2006

(51) Int. Cl. A61G 17/00

(52) U.S. Cl. 27/1

(57) ABSTRACT

A structure for connecting cremation ashes with living plants comprising a plant and at least one from the group consisting of cremated remains in a cavity of the plant and a link located in a cavity of the plant, the link connecting with the cremated remains. The structure may further comprise a vessel for holding the cremated remains and a memorial structure connected to the link. The structure is meant to create a living memorial for the deceased.

### FIELD OF THE INVENTION

This invention relates generally to structures and methods used for preserving and memorializing the remains of humans and animals. In particular, the present invention is directed to providing a crematory urn assembly that connects ash remains with a living plant.

### BACKGROUND OF THE INVENTION

The popularity of cremation is growing within modern society as an alternative to preserving bodies and burying them in coffins. Cremation is also becoming a popular method of dealing with pet remains. Cremation is usually less expensive and more ecological than burial. It also offers living individuals an opportunity to keep some of the deceased's ashes close to them. Often a memorial is created at the location of the cremated remains to commemorate the deceased's life and provide a focal point to connect with the deceased's spirit.

In death, many individuals wish to continue a connection or link to the living world. This connection may be spiritual between the deceased and their relatives or the connection may take a more physical form such as between the deceased's remains and nature. For example, the deceased may wish to have their remains incorporated into a living tree. U.S. Pat. No. 5,799,488 to Truong and U.S. Pat. No. 6,516,501 to Vázquez-Pérez both propose mixing ashes with soil and planting a tree that will grow from the mixture. A plaque may be attached to the tree to identify specific remains with a specific tree. In a similar approach, U.S. Pat. No. 5,815,897 to Longstreth provides for a planter having a vault for holding cremation remains. The plant grows near the ashes, but the plant is not integrally linked to the ashes.

The above mentioned options offer some degree of integration between a particular deceased's ashes and a particular living tree or plant. These options, however, do not address other possibilities for connecting with a plant such as entombment of the remains within the plant, multiple connections of multiple individual's remains with a single plant, or temporary links to a plant allowing for future movement of the ashes. Furthermore prior art options do not provide for both the integration of the ash remains with a plant and an additional connection for a loved one to connect with the ashes.

### SUMMARY OF THE INVENTION

One aspect of the present invention is directed to a structure for connecting cremated remains to a living plant comprising a plant and at least one from the group consisting of cremated remains in a cavity and a link located in a cavity, the link connects with the cremated remains.

Another aspect is directed to a structure for connecting cremated remains to a living plant comprising a vessel for holding cremated remains and a cavity cut within the plant, the vessel at least partially contained within the cavity.

Another aspect is directed to a structure for connecting cremated remains to a living plant comprising a vessel containing cremated remains and a link with first and second ends. The first end of the link is in contact with the remains and the second end of the link is for placement in a cavity cut within the plant.

Yet another aspect is directed to a method of connecting cremated remains to a living plant comprising forming a cavity in a living plant and at least one from the group consisting of placing cremated remains in the cavity and providing a link connecting the cremated remains with the cavity.

Still another aspect is directed to a method of connecting cremated remains to a living plant comprising providing a vessel containing the remains; creating a cavity within a portion of the plant; placing the vessel within the cavity; and allowing the plant to grow around the vessel.

Still yet another aspect is directed to a method of connecting cremated remains to a living plant comprising providing a vessel containing the remains, the vessel including a link with first and second ends, the first end in contact with the remains and the second end extending outward from the vessel; creating a cavity within a portion of the plant; placing the second end within the opening; and allowing the plant to grow around the second end to create a connection between the plant and the remains.

### BRIEF DESCRIPTION OF DRAWINGS

The foregoing and other aspects and advantages of the invention will be apparent from the following detailed description of the invention, as illustrated in the accompanying drawings, in which:

FIG. 1a is a sectional view of a structure for connecting cremation ashes with a living plant according to the present invention illustrating placement of a vessel containing crematory remains within a hole drilled in a tree;

FIG. 1b is a sectional view of the structure in FIG. 1a after several years have passed and the tree has entombed the vessel containing crematory remains;

FIG. 2a is a sectional view of a porous vessel containing ashes that has been placed within a hole drilled in a tree;

FIG. 2b is a sectional view of the structure in FIG. 2a after several years have passed, the tree has entombed the vessel and a portion of the ashes have been assimilated into the tree;

FIG. 3a is a sectional view of a biodegradable vessel containing ashes that has been placed within a hole drilled in a tree;

FIG. 3b is a sectional view of the structure in FIG. 3a after several years have passed, the tree has entombed the remains, the vessel has degraded, and a portion of the ashes have been assimilated into the tree;

FIG. 4a is a sectional view of a vessel for holding cremated remains according to one embodiment of the present invention.

FIG. 4b is a sectional view of a vessel for holding cremated remains according to another embodiment of the present invention.

FIG. 4c is a sectional view of a vessel for holding cremated remains according to yet another embodiment of the present invention.

FIG. 5a is a sectional view of an embodiment of the present invention in which the vessel with crematory ashes includes a link, the vessel placed within a hole drilled in a tree;

FIG. 5b is a sectional view of the structure in FIG. 5a after several years have passed, the tree has entombed the remains and the link extends between the ashes and a memorializing plaque;

FIG. 6a is a sectional view of an alternative embodiment of the present invention with the link passing throughout the length of the vessel containing remains and the link extending outward from the tree to provide a portion of the link for touching by a loved one;

FIG. 6b is a sectional view of an alternative embodiment of the present invention with the link being a telescoping connection to the memorial structure;

FIG. 7a is a side elevation view of a cactus connected with cremated remains;

FIG. 7b is a sectional view of a vessel containing remains connected to a cactus;

FIG. 8 is a side elevation view of a family burial tree containing multiple apparatus for connecting multiple remains within one tree;

FIG. 9a is a sectional view of a memorializing vessel according to the present invention attached to the outside of a tree and having a tube linking ashes from within the vessel to a cavity created within the tree;

FIG. 9b is a side elevation view of the memorializing vessel in FIG. 9a;

FIG. 10a is a sectional view of a structure according to the present invention illustrating a cord linking the ashes contained within a vessel to two recessed cavities within a tree;

FIG. 10b is a sectional view of a structure according to the present invention illustrating a bag and link arrangement to connect ashes from a vessel to the tree;

FIG. 11a is a side perspective view illustrating grafting a cord to a house plant, the cord linked to ashes in an urn;

FIG. 11b is a side perspective view illustrating grafting a cord to a tree, the cord linked to ashes in a memorializing vessel;

FIG. 12a is a side elevation view of a memorializing vessel designed as a cross;

FIG. 12b is a side elevation view of a memorial structure designed in the shape of the Star of David;

FIG. 12c is a plan view of a disc shaped memorializing pendant that is attached to a cord; and

FIG. 12d is a plan view of a memorializing plaque that may be attached to a cord.

### DETAILED DESCRIPTION OF THE INVENTION

The present invention provides for a structure and method of connecting cremation remains with living plants. Although most of the embodiments are illustrated as occurring between cremation remains and a living tree, it is understood that other plants could be substituted for the tree and achieve the same results. The plant could be any plant including, but not limited to a tree, a cactus, a vine or a houseplant.

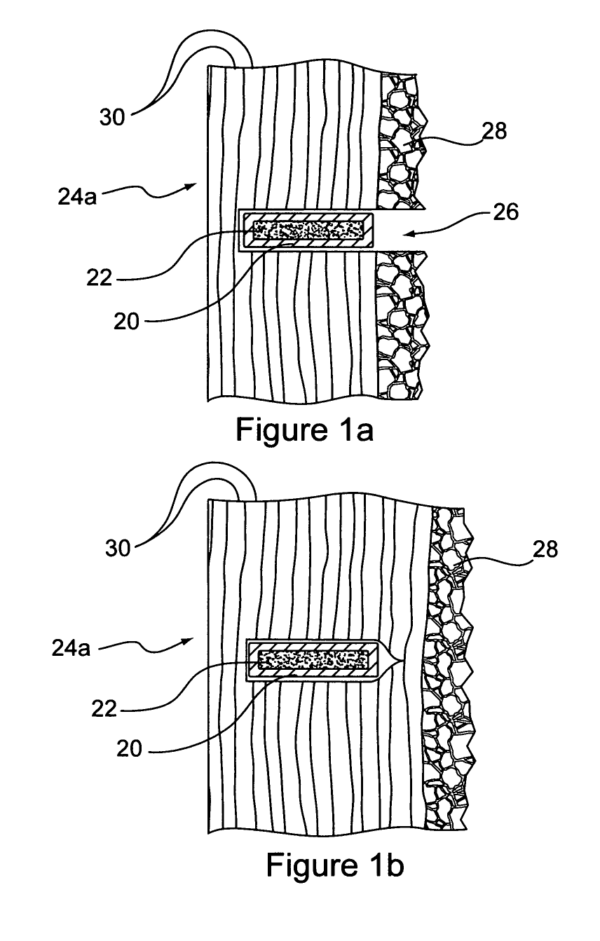

As illustrated in FIGS. 1a and 1b, a vessel 20 (a.k.a., urn) is prepared containing cremation remains 22 (a.k.a., cremation ashes). The cremation remains may be that of a human or a pet. Preparation of remains 22 in vessel 20 may occur at the crematorium or one may fill and prepare the vessel from ash remains they already have in their possession. The size, form and composition of vessel 20 are selected based on the size and type of living plant 24 to which remains 22 will be connected. In this particular embodiment, plant 24 is a tree 24a. Tree 24a may be a tree for which the deceased had a particular attachment to during life and that grows near their home or it may be a tree that is growing in a particular cemetery for the purpose of acting as a living memorial. A cavity 26 is created in a portion of tree 24a as shown in FIG. 1a. Cavity 26 may be created by drilling, cutting, sawing or any other means for creating an appropriately shaped cavity in a portion of tree 24a. Cavity 26 goes through bark 28 and into growth rings 30. Vessel 20 containing remains 22 is placed within cavity 26. Over time as shown in FIG. 1b, tree 24a grows outward and around the exposed end of vessel 20 entombing the remains. Remains 22 are surrounded by growth rings 30 and connected to tree 24a through vessel 22.

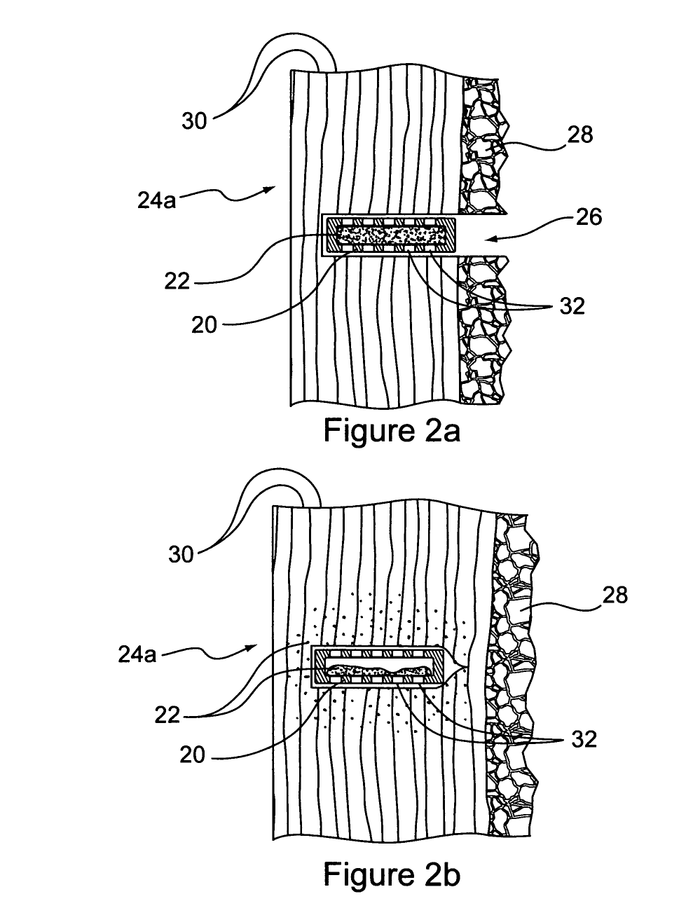

As illustrated in FIGS. 2a and 2b, cremation remains 22 may be more integrally connected with living plant 24 by allowing some of the remains to pass through the walls of vessel 20 and into the plant. In this embodiment as shown in FIG. 2a, vessel 20 is a porous vessel with pores 32. Vessel 20 contains cremated remains 22. A cavity 26 is created in plant 24 or tree 24a and vessel 20 is placed within the cavity. Over time as shown in FIG. 2b, tree 24a grows around vessel 20. Fluids or sap from within tree 24a pass through pores 32 of vessel 20 and mixes with remains 22. Remains 22 diffuse into the sap and are transported from vessel 20 throughout tree 24a. This creates an integral connection between remains 22 and tree 24a by allowing some of the remains to be assimilated into the tree as it grows.

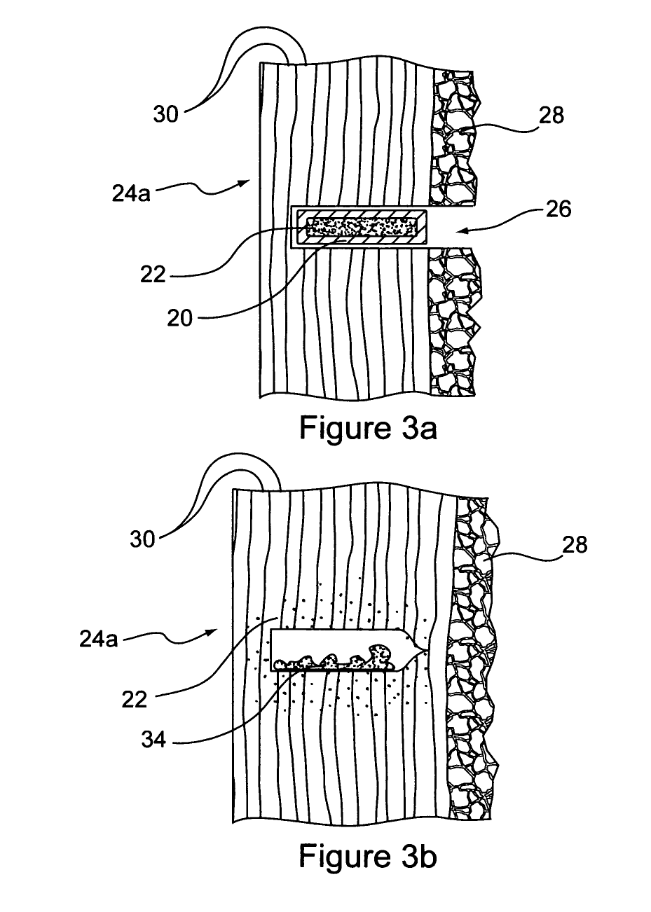

Another embodiment of the present invention that allows for remains 22 to be assimilated into tree 24a as it grows is illustrated in FIGS. 3a and 3b. Here vessel 20 is a biodegradable vessel. As shown in FIG. 3a, vessel 20 containing cremated remains 22 is placed in cavity 26 created within tree 24a. Over time as shown in FIG. 3b, tree 24a grows around vessel 20. Fluids or sap from within tree 24a come in contact with vessel 20, breaking it down into a mixture of remains 22 and degrade vessel 34. Vessel 20 may be fabricated from any number of biodegradable materials including but not limited to sugars, starches, wood dust held together by water soluble glue or other suitable biodegradable material. Remains 22 then diffuse into the sap and are transported throughout tree 24a.

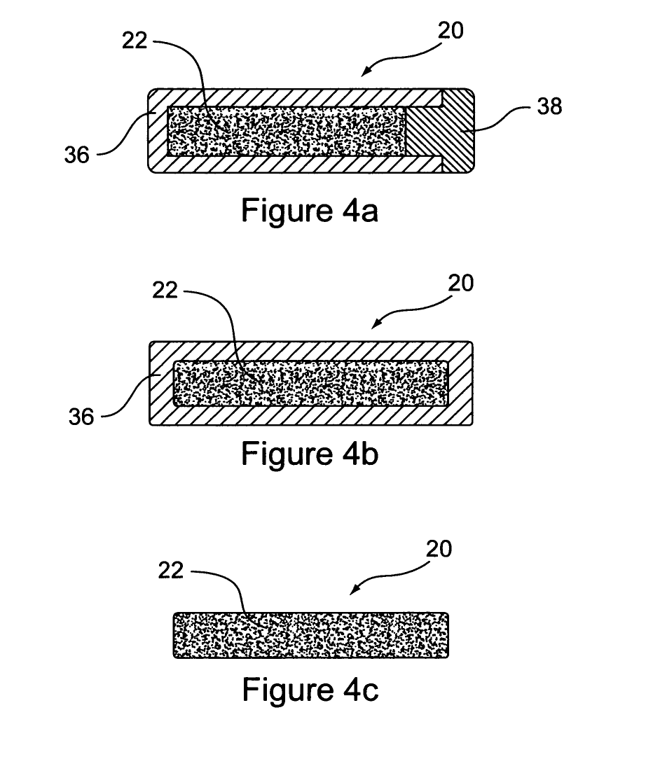

FIGS. 4a-4c illustrate several types of vessels 20 that may be used for placement of cremated remains 22 within a cavity created within a plant 24. FIG. 4a shows a vessel 20 that comprises a containment element 36 and a cap 38. After containment element 36 is filled with cremated remains 22, cap 38 is used to seal in the remains. The seal between containment element 36 and cap 38 may be made by screwing, pressing fitting, gluing or any other sealing technique. Vessel 20 may be fabricated from wood, plastic, metal, ceramic, organics, composites or other suitable materials. The materials may be porous or biodegradable. FIG. 4b shows a vessel 20 that includes a single containment element 36 that is formed around remains 22. Similarly, vessel 20 may be fabricated from a single containment element have an opening that is then sealed upon itself. Containment element 36 of vessel 20 may be only partially filled with remains 22. FIG. 4c shows a vessel 20 that is a composite structure 40 including remains 22. In structure 40, remains 22 may be mixed or layered with another material to create vessel 22. For example, maple sugar might be mixed with remains 22 to form a solid vessel 20 or plug that fits within a cavity of a maple tree. This vessel would be biodegradable and absorbed into the tree. The shape of vessels 20 have been shown primarily as cylinders. This shape easily fits within a hole drilled in a plant or tree. However, it is understood that any appropriately sized and shaped vessel that can fit within the cavity created is acceptable.

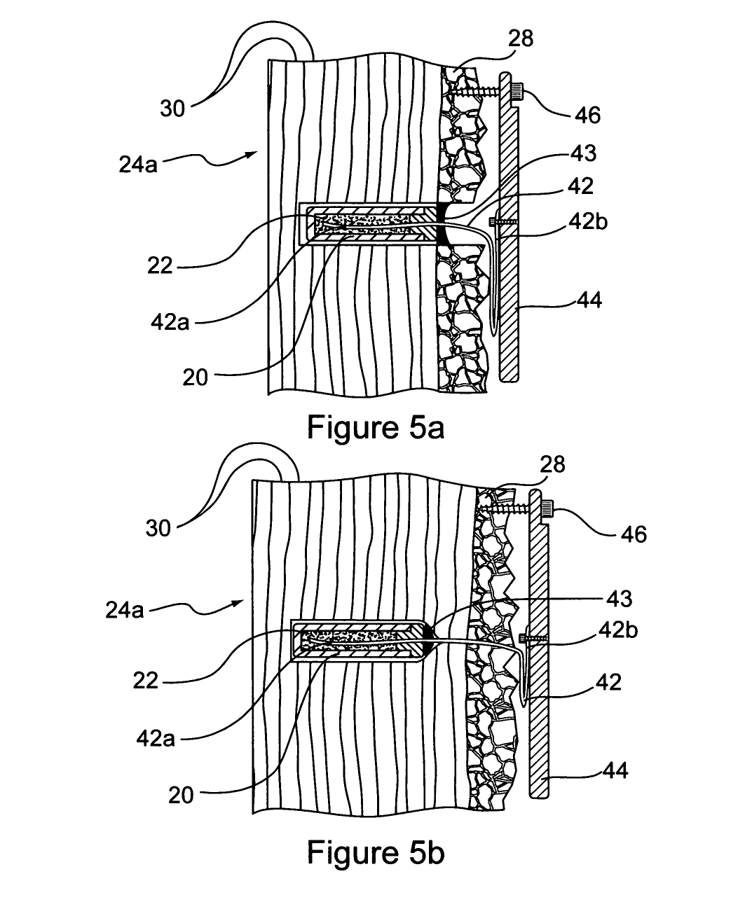

FIGS. 5a and 5b illustrate the addition of a link 42 to the structure for connecting cremated remains 22 with living plant 24, here a tree 24a. Link 42 offers an additional way of connecting to remains 22. As shown in FIG. 5a, vessel 20 containing cremated remains 22 is placed in cavity 26 created within tree 24a. Link 42 has a first end 42a and second end 42b. First end 42a is in contact with cremated remains 22. Link 42 may extend from vessel 20 or from within the vessel itself. Second end 42b extends outward from tree 24a through cavity 26. A sealant 43 may be applied to fill a portion of cavity 26, or around link 42, to seal out moisture or insects from getting into the cavity. Sealant 43 may be chosen from the group of materials including, but not limited to a caulking compound, putty, wax, PLASTIC WOOD® or tar based compounds. Although first shown in this embodiment, sealant 43 may be used in any of the embodiments of to the present invention. Over time as shown in FIG. 5b, tree 24a grows around vessel 20 and around link 42. Link 42 may be a flexible cord, a rope, a wire or other material. At any time, link 42 extending from tree 24a may be touched by a love one to connect physically and spiritually with the deceased's ashes.

In alternative embodiment, vessel 20 containing cremated remains 22 could be inserted into cavity 26 so that link 42 fits within the cavity and makes a direct connection with tree 24a. Vessel 20 could also have a link 42 that passes through both ends of the vessel so that the link may contact tree 24a at one end and simultaneously have the other end of the link extend outward from the tree for human contact.

Additionally, one may wish to provide a memorial structure 44 as illustrated in FIGS. 5a and 5b. Memorial structure 44 may be a plaque, photo or other appropriate structure for commemorating the life of the deceased. Memorial structure 44 may be attached to the link's second end 42b extending from tree 24a. Memorial structure 44 may be attached to tree 24a by a screw 46 or other fastener. Sufficient length should be provided for link 42 so that as tree 24a grows the connection with memorial structure 44 is kept intact. The overall structure provides for a connection through link 42 between remains 22 and memorial structure 44. A connection is also made between remains 22 and tree 24a via vessel 20 and link 42. Any of the vessels 20 previously described may be integrated with link 42.

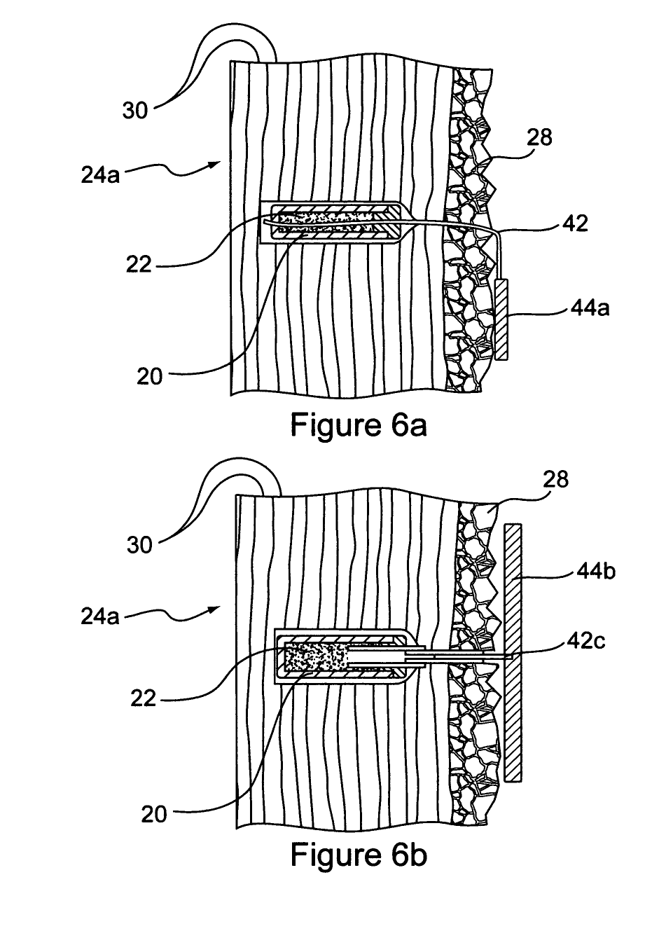

FIGS. 6a and 6b illustrate two other embodiments for a memorial structure 44 attached to a link 42 that connects with cremated remains 22. FIG. 6a shows a pendant 44a for memorializing the deceased freely hanging from link 42. FIG. 6b shows a telescoping link 42c with a memorial plaque 44b attached to the link. This structure also allows for keeping an intact connection between cremated remains 22 and memorial structure 44 as tree 24a grows outward.

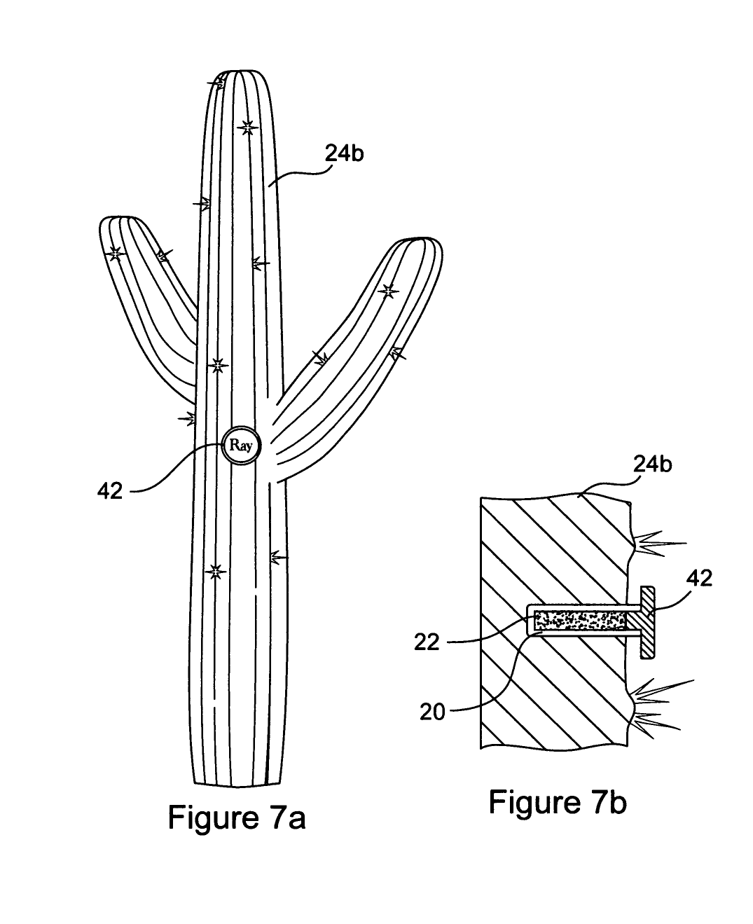

FIGS. 7a and 7b illustrate yet another embodiment where vessel 20 containing cremated remains 22 is placed partially within cavity 26 cut within plant 24. Here plant 24 is a cactus 24b. Vessel 20 is linked directly to a memorial structure 42. Cactus 24b may not totally entomb vessel 20, but rather seal around it. This type of connecting structure works well for a saguaro cactus and other similar plants, plants where the diameter does not grow rapidly relative to its height. Vessel 20 could be a non-biodegradable, biodegradable or porous vessel. Sealant may also be used at the opening of the cavity to protect against bugs, microbes and moisture.

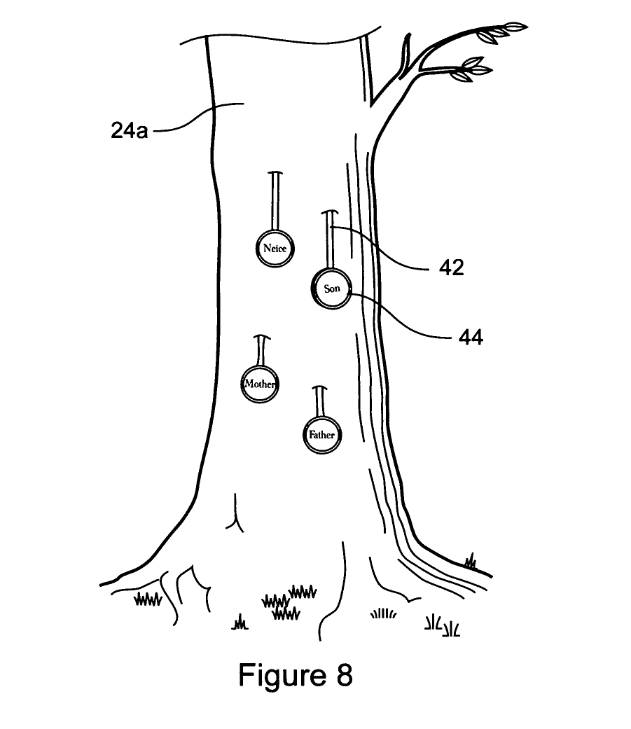

FIG. 8 illustrates the structure of a family burial tree. It is possible to connect ash remains from several deceased humans or pets to one living plant. Such a structure is an important in perpetuating the concept of family after death. Tree 24a may reside in ones back yard or in a cemetery specifically designed for creating a connection between multiple deceased individuals and living plants. As each pet or person is cremated, a portion of their ashes may be placed within a cavity created within tree 24a. Connected to the remains and exiting from tree 24a is a link 42 with a memorial structure 44 identifying each individual's remains. Since many trees may live for hundreds of years, it is possible to combine many generations into one living tree. If for some reason the tree dies, or one is forced to move, that portion of the tree containing the remains may be cut down and turned into a memorial that can be kept in ones home and moved as needed. The cut portion of the tree may be turned into a piece of furniture or sculpture with the remains intact.

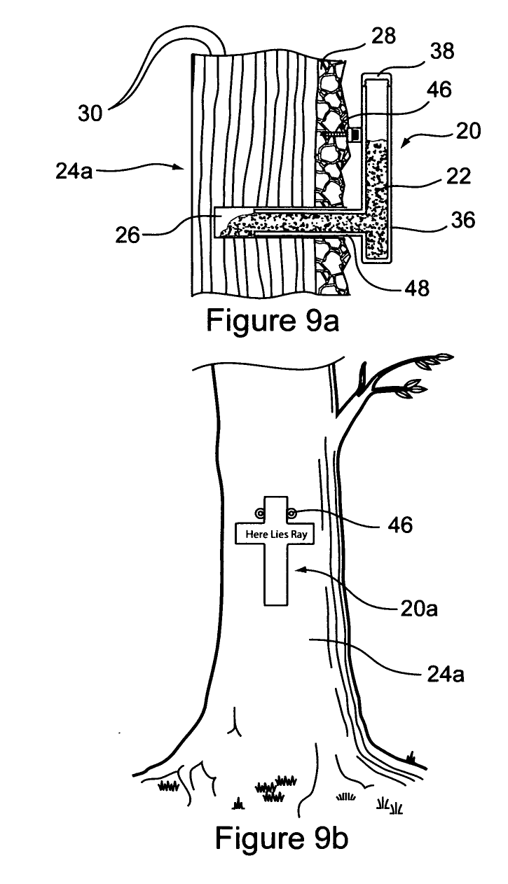

As illustrated in FIGS. 9a and 9b, vessel 20 containing cremated remains 22 may reside outside the plant 24 or tree 24a and a connection made between the vessel and tree. In this particular embodiment of the present invention vessel 20 (a.k.a., urn) takes the form of a cross 20a. In essence, vessel 20 becomes the memorial structure 44. Vessel 20 comprises a containment element 36 and a cap 38. Vessel 20 may be fabricated from wood, metal, ceramic, organics, composites or other suitable materials. Cremated remains 22 are placed within containment element 36 and sealed with cap 38. Near the base of vessel 20, the vessel further comprises a tube 48, functioning as a link, to fit within a cavity 26 cut within tree 24a. Vessel 20 is attached to tree 24a by a screw 46 or other fastener. As time passes, living tree 24a grows around tube 48. Cremated remains 22 connect with tree 24a through tube 48. Some portion of remains 22 may be assimilated into tree 24a.

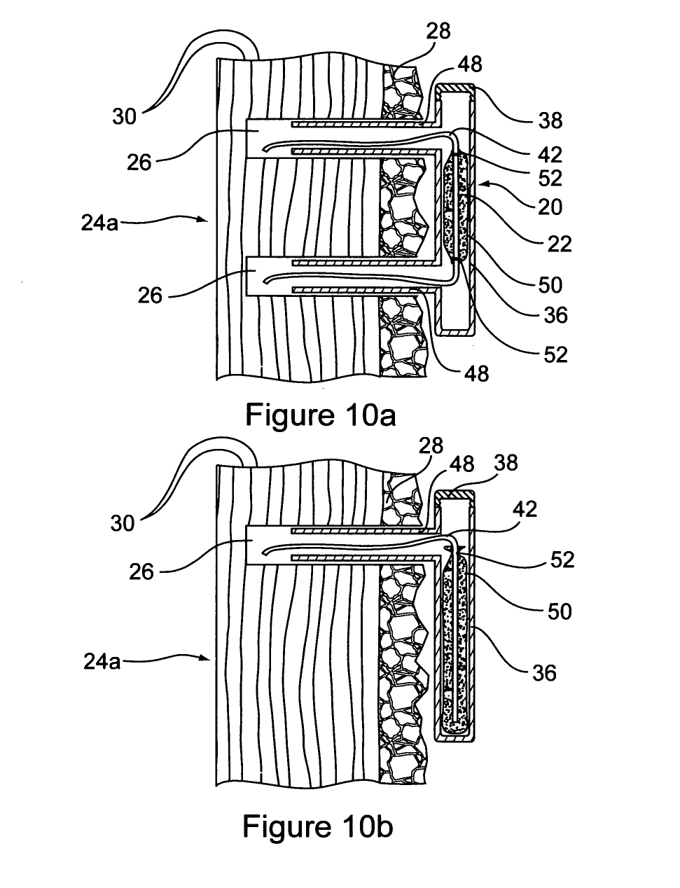

FIGS. 10a and 10b illustrate two additional embodiments for housing cremated remains 22 outside living plant 24 and making a connection to the plant. As shown in FIG. 10a, vessel 20 has two tubes 48, functioning as two links, that are placed within two cavities 26 cut within a tree 24a. Vessel 20 may have an additional means for attachment to tree 24 or the two tubes 50 may fit snuggly in cavities 26 to hold the vessel to the tree. Cavities 26 may also be sealed with a sealant. Cremated remains 22 are housed within containment element 36 and protected from the environment by cap 38. Cremated remains 22 are placed within a bag 50 that has seals 52. A second link 42, which may be a flexible cord, rope or wire, passes through remains 22, through seals 52, through tubes 48 and into cavities 26 to make contact with tree 24a. In a different variation FIG. 10b shows vessel 20 with a single tube 48 near its top. Cremated remains 22 are housed within containment element 36 and protected from the environment by cap 38. Cremated remain 20 are placed within a bag that has a tied seal 52. Link 42 in contact with remains 22 passes through seal 52 and connects with tree 24a in cavity 26.

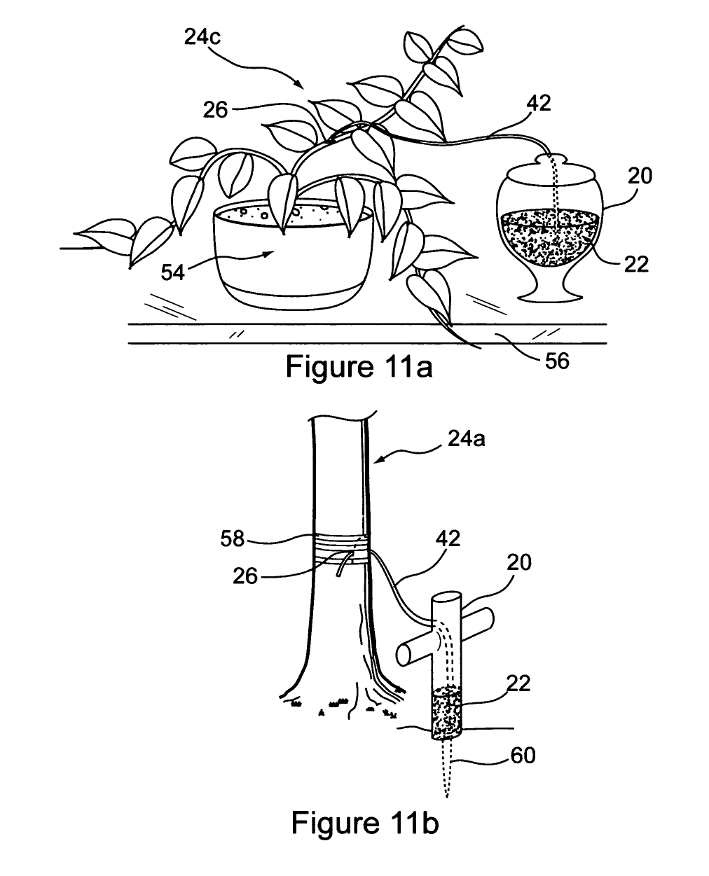

Grafting may also be used as a way of connecting cremation remains with a living plant according to the present invention. Instead of grafting a portion of another plant to the living plant on wishes to graft to, a link connecting with the cremated remains is grafted to the living plant. FIGS. 11a and 11b illustrate two structures according to this embodiment. FIG. 11a shows a house plant 24c, such as ivy, growing in a pot 54 on a table 56 within a home. A vessel 20 (a.k.a., urn) is placed beside plant 24c on table 56. Vessel 20 contains cremated remains 22. A link 42 in contact with remains 22 connects between the remains and plant 24c. Link 42 is placed within a cavity 26 cut with living plant 24c. Over time, cavity 26 seals and grows around link 42 to create a connection between cremated remains 22 and plant 24c. Similarly, FIG. 11b shows grafting of a link 42 to a young tree 24a. A cut is made to create cavity 26 within tree 24a. Link 42 is placed within cavity 26. Cavity 26 is closed and grafting tape 58 used to seal the cavity. An additional sealant or wax may also be used. Over time, tree 24a will grow around link 42. Link 42 extends into a vessel 20 that contains cremated remains 22. Vessel 20 may take the form of a memorializing structure and be held in place by a stake 60 attached to the vessel that is pushed into the ground. As tree 24a grows to be large enough, vessel 20 may be attached directly to the tree.

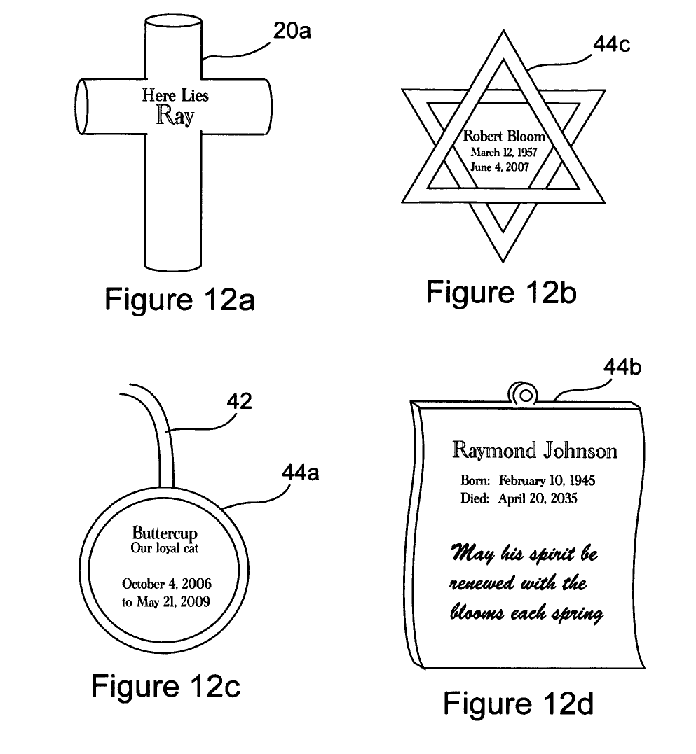

FIGS. 12a-d show several examples of memorializing structures that may be used to locate or store remains that connect to a plant. FIG. 12a illustrates a vessel 20a that both stores cremated remains and memorializes the deceased's Christian faith. FIG. 12b illustrates a memorializing plaque structure 44c that symbolizes the deceased's Jewish faith. FIG. 12c illustrates a pendant 44a that may be attached to a link locating the remains of a cat's cremated remains entombed within a tree. FIG. 12d illustrates a design for a plaque 44b that may be hung on a tree locating and memorializing a deceased's remains.

The embodiments of the current invention that do not entomb the cremated remains within a plant offer another advantageous feature not provided by the prior art in that the link between the living plant and remains can be severed and the remains moved to link with a new plant. This feature is nice in that it allows for a loved one to take ashes with them if they move and create a new link to a living plant for the deceased's remains. For example in FIGS. 11a and 11b the grafted link would be cut near the plant and may be re-grafted to a new plant.

Throughout the present invention cremated remains have been connected with the living plant. In an alternative embodiment, it is possible that a keepsake of the deceased's or a piece of the deceased's body such as hair could be placed with a vessel. A connection with the keepsake or other artifact from the deceased can be made in a similar manner with the living plant.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

What is claimed is:

1) A structure for connecting cremated remains to a living plant, comprising:
said plant having a cavity; and at least one from the group consisting of said cremated remains in said cavity and a link located in said cavity, wherein said link connects with said cremated remains.

2) A structure as recited in claim 1, further comprising a memorial structure connected to said link.

3) A structure as recited in claim 2, wherein said cremated remains are located inside said cavity and said link extends from said cremated remains to said memorial structure.

4) A structure as recited in claim 1, wherein said cremated remains are located outside said cavity and said link extends from said cremated remains to said cavity.

5) A structure as recited in claim 1, further comprising a vessel for holding said cremated remains.

6) A structure as recited in claim 1, further comprising a bag for holding said cremated remains, said bag is located in said vessel.

7) A structure as recited in claim 1, further comprising a plurality of said links connected to said plant.

8) A structure as recited in claim 1, wherein said plant is at least one from the group including a tree, a cactus, a vine and a house plant.

9) A structure for connecting cremated remains to a living plant, comprising:
a vessel for holding said cremated remains and a cavity cut within said plant, said vessel at least partially contained within said cavity.

10) A structure as recited in claim 9, further comprises a link extending from said cremated remains to the outside of said plant.

11) A structure as recited in claim 9, wherein said link is a flexible cord.

12) A structure as recited in claim 9, wherein said link telescopes to increase in length.

13) A structure as recited in claim 9, further comprising a memorial structure attached to said link outside said plant.

14) A structure as recited in claim 9, further comprising a sealant applied to a portion of said cavity for sealing out moisture, microbes and insects.

15) A structure as recited in claim 9, wherein said vessel is at least one from the group including a non-biodegradable vessel, a biodegradable vessel and a porous vessel.

16) A structure as recited in claim 9, wherein said vessel is fabricated out of at least one from the group including wood, plastic, metal, ceramic, organics, composites and a composite structure including said remains.

17) A structure as recited in claim 9, wherein said plant is at least one from the group including a tree, a cactus, a vine and a house plant.

18) A structure for connecting cremated remains to a living plant, comprising:
a vessel containing cremated remains and a link with first and second ends, said first end in contact with the remains and said second end for placement in a cavity cut within the plant.

19) A structure as recited in claim 18, wherein said link is a flexible cord.

20) A structure as recited in claim 19, wherein said flexible cord is at least one from the group including wire and organic fibers.

21) A structure as recited in claim 18, wherein said vessel is a memorial structure.

22) A structure as recited in claim 18, further comprising a bag for holding said cremated remains within said vessel.

23) A method of connecting cremated remains to a living plant, comprising:
forming a cavity in a living plant; and at least one from the group consisting of placing cremated remains in said cavity and providing a link connecting said cremated remains with said cavity.

24) A method as recited in claim 23, wherein forming said cavity involves at least one from the group including drilling, sawing or cutting.

25) A method as recited in claim 23, further comprising placing said cremated remains in a vessel and placing said vessel in said cavity.

26) A method as recited in claim 23, further comprising providing said cremated remains in a vessel wherein said link extends from said vessel.

27) A method as recited in claim 23, further comprising providing said cremated remains in a vessel wherein said link extend from within said vessel.

28) A method as recited in claim 23, further comprising allowing said plant to grow around said cremated remains.

29) A method as recited in claim 23, further comprising allowing said plant to grow around said link.

30) A method as recited in claim 23, further comprising attaching a memorial structure to said plant.

31) A method as recited in claim 30, wherein said link connects between said cremated remains and said memorial structure.

32) A method of connecting cremated remains to a living plant, comprising:
providing a vessel containing said cremated remains; creating a cavity within a portion of said plant; placing said vessel within said cavity; and allowing said plant to grow around said vessel.

33) A method as recited in claim 32, further comprising sealing a portion of said cavity to seal out moisture, microbes and insects.

34) A method as recited in claim 32, further comprising allowing said plant to grow completely around said vessel entombing said cremated remains.

35) A method as recited in claim 32, further comprising allowing said vessel to degrade and said plant absorbing a portion of said cremated remains.

36) A method as recited in claim 32, further comprising providing a link with first and second ends, said first end in contact with said cremated remains and said second end extending outward from said plant.

37) A method as recited in claim 36, further comprising attaching an identifying memorial structure to said second end.

38) A method of connecting cremated remains to a living plant, comprising;
providing a vessel containing said cremated remains, said vessel including a link with first and second ends, said first end in contact with said remains and said second end extending outward from said vessel; creating a cavity within a portion of said plant; placing said second end within said opening; and allowing said plant to grow around said second end to create a connection between said plant and said remains.

39) A method as recited in claim 38, further comprising attaching said vessel to said plant.

40) A method as recited in claim 38, further comprising placing said vessel on a surface next to said plant.
